(19) United States
(12) Patent Application Publication
(10) Pub. No.: US 2026/0181540 A1
(43) Pub. Date: Jun. 25, 2026

(54) DATA TRANSMISSION METHOD AND APPARATUS, SYSTEM, ELECTRONIC DEVICE, AND STORAGE MEDIUM

(71) Applicant: HANGZHOU SUPERACME MICROELECTRONICS TECHNOLOGY CO., LTD., Binjiang District, Zhejiang (CN)

(72) Inventors: Jun Liu, Hangzhou (CN); Chenyu She, Hangzhou (CN); Zuoxing Yang, Hangzhou (CN); Guo Ai, Hangzhou (CN)

(21) Appl. No.: 18/834,534

(22) PCT Filed: Mar. 21, 2024
(86) PCT No.: PCT/CN2024/082846

§ 371 Date: Jul. 30, 2024

(30) Foreign Application Priority Data
May 9, 2023 (CN) 202310528513.9

(51) Int. Cl. H04W 48/18; H04W 84/12; H04W 88/04

(52) U.S. Cl. CPC H04W 48/18; H04W 84/12; H04W 88/04

(57) ABSTRACT

Embodiments of the present disclosure provide a data transmission method and apparatus, a system, an electronic device, and a storage medium. The method is applied to a relay device in an intelligent collecting system including a host device and the relay device independently deployed within short range; the relay device includes a first network module configured to access a first network and a second network module configured to access a second network; the method includes: receiving from the host device first data including environmental data collected by the host device; selecting the first network or the second network as an access network for accessing a wide area network according to a network quality of the first network and the second network; and transmitting second data to a cloud platform connected with the wide area network through the access network, the second data including the environmental data.

### CROSS-REFERENCE TO RELATED APPLICATIONS

This application is a U.S. National Phase application under 35 U.S.C. § 371 of International Application No. PCT/CN2024/082846, filed on Mar. 21, 2024. This application claims the benefit and priority to Chinese Patent Application No. 202310528513.9, entitled “Data Transmission Method and Apparatus, System, and Readable Storage Medium”, filed to China National Intellectual Property Administration on May 9, 2023, the entire contents of each of the above applications are incorporated herein by reference.

### FIELD

The present disclosure relates to the technical field of home automation, and particularly to a data transmission method and apparatus, a system, an electronic device, and a storage medium.

### BACKGROUND

This section provides background information related to the present disclosure which is not necessarily prior art.

With the rapid development of smart home technology, intelligent doorbells are gradually replacing traditional peepholes and doorbells. The intelligent doorbell integrates the functions of a traditional doorbell and a camera and prompt functions. It has not only the function of the traditional doorbell, but also plays the role in anti-theft and security.

The intelligent doorbell is usually installed outdoors and powered by batteries. It may collect images or videos in front of the door and upload the collected images or videos to a cloud platform. Then, the collected images or videos may be transmitted to a user terminal (such as a mobile phone of a user) through the cloud platform so that the user may check them at anytime and anywhere.

### SUMMARY

This section provides a general summary of the disclosure, and is not a comprehensive disclosure of its full scope or all of its features.

Various embodiments provide a data transmission method and apparatus, a system, an electronic device, and a readable storage medium, which may improve the stability and reliability for transmitting data to a cloud platform by a host device of an intelligent collecting system.

An embodiment of the present disclosure discloses a data transmission method, executable by a relay device in an intelligent collecting system, where the intelligent collecting system includes a host device and the relay device independently deployed within a short range; the relay device includes a first network module and a second network module, the first network module is configured to access a first network, and the second network module is configured to access a second network; and the method includes:
receiving first data transmitted by the host device, the first data including environmental data collected by the host device;
selecting the first network or the second network as an access network for accessing a wide area network according to a network quality of at least one of the first network and the second network; and
transmitting second data to a cloud platform connected with the wide area network through the access network, the second data including the environmental data.

Another embodiment of the present disclosure discloses a data transmission apparatus, applied to a relay device in an intelligent collecting system, where the intelligent collecting system includes a host device and the relay device independently deployed within a short range; the relay device includes a first network module and a second network module, the first network module is configured to access a first network, and the second network module is configured to access a second network; and the apparatus includes:
a first receiving module, configured to receive first data transmitted by the host device, the first data including environmental data collected by the host device;
a target determination module, configured to select the first network or the second network as an access network for accessing a wide area network according to a network quality of at least one of the first network and the second network; and
a first transmitting module, configured to transmit second data to a cloud platform connected with the wide area network through the access network, the second data including the received environmental data.

Another embodiment of the present disclosure discloses an intelligent collecting system, where the intelligent collecting system includes a host device and a relay device independently deployed within a short range; the relay device includes a first network module and a second network module, the first network module is configured to access a first network, and the second network module is configured to access a second network;

the host device is configured to collect environmental data and transmit first data to the relay device, the first data including the environmental data collected by the host device;

the relay device is configured to receive the first data transmitted by the host device, select the first network or the second network as an access network for accessing a wide area network according to a network quality of at least one of the first network and the second network, and transmit second data to a cloud platform connected with the wide area network through the access network, the second data including the environmental data.

Another embodiment of the present disclosure discloses an electronic device, including:
one or more processors; and
a memory connected to the processor and configured to store one or more programs which, when executed by the one or more processors, cause the electronic device to implement the foregoing data transmission method.

Another embodiment of the present disclosure discloses a non-transitory computer-readable storage medium having stored thereon instructions which, when executed by one or more processors of an apparatus, cause the apparatus to perform the foregoing data transmission method.

Another embodiment of the present disclosure discloses a computer program product including a computer program which, when executed by a computer, implements the foregoing data transmission method.

Further areas of applicability will become apparent from the description provided herein. The description and specific examples in this summary are intended for purpose of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic structural diagram of a data transmission system according to some embodiments of the present disclosure;

FIG. 2 is a flowchart illustrating a data transmission method according to some embodiments of the present disclosure;

FIG. 3 is a schematic structural diagram of an intelligent collecting system according to some embodiments of the present disclosure;

FIG. 4 is a flowchart illustrating another data transmission method according to some embodiments of the present disclosure;

FIG. 5 is a block diagram illustrating a data transmission apparatus according to some embodiments of the present disclosure; and

FIG. 6 is a schematic structural diagram of an electronic device according to some embodiments of the present disclosure.

### DETAILED DESCRIPTION

The technical solutions in the embodiments of the present disclosure will be clearly and completely described below in conjunction with the accompanying drawings in the embodiments of the present disclosure, and it is obvious that the described embodiments are a part of the embodiments of the present disclosure, not all embodiments. Based on the embodiments in the present disclosure, all other embodiments obtained by a person skilled in the art without involving any inventive effort fall within the scope of the present disclosure.

The terms “first”, “second”, and the like in the description and claims of the present disclosure are used to distinguish similar objects and are not used to describe a specific order or sequence. It should be understood that the data so used are interchangeable under appropriate circumstances so that the embodiments of the present disclosure can be implemented in orders other than those illustrated or described herein. In addition, objects distinguished by “first”, “second”, etc. are generally one type and do not limit the number of objects, for example, the first object may be one or more. Further, the term “and/or” in the description and claims is used to describe an associated relationship of associated objects to indicate that there may be three relationships. For example, A and/or B may indicate that: there are three cases of A alone, A and B together, and B alone. The character “/” generally indicates that the associated objects are an “or” relationship. The term “a plurality of” in the embodiments of the present disclosure means two or more, and other quantifiers are similar.

In some embodiments, in order to achieve the long standby of an intelligent doorbell, the intelligent doorbell usually transmits data to a cloud platform using wireless fidelity (WiFi) communication with low power consumption. However, since the intelligent doorbell is installed outdoors, an iron door will shield the WiFi signal in the user's room. Additionally, the WiFi signal is susceptible to interference and may be unstable, resulting in the intelligent doorbell being unable to transmit data normally, thus affecting a playing function of a user terminal.

In order to solve the above-mentioned problems, various embodiments of the present disclosure provide a data transmission method, which can improve the stability and reliability of a host device of the intelligent doorbell transmitting data to the cloud platform. The following description is made in conjunction with the accompanying drawings.

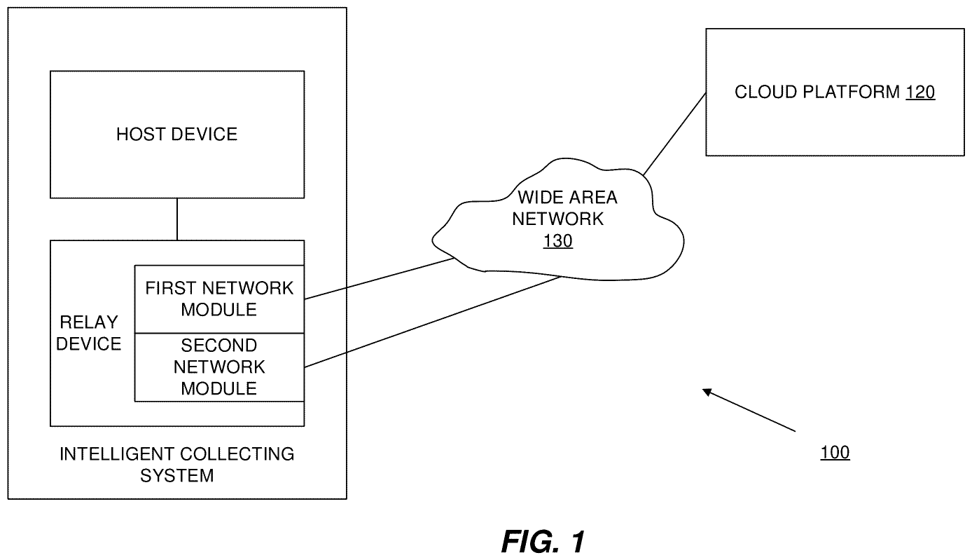

Referring to FIG. 1, it shows a schematic structural diagram of a data transmission system 100 according to some embodiments of the present disclosure. The data transmission system 100 may include an intelligent collecting system 110, a wide area network 130, and a cloud platform 120 connected with the wide area network. The intelligent collecting system 110 may include a host device and a relay device deployed within a short range. The relay device includes a first network module and a second network module, the first network module is configured to access a first network, and the second network module is configured to access a second network. The relay device may select the first network or the second network as an access network to access the wide area network 130.

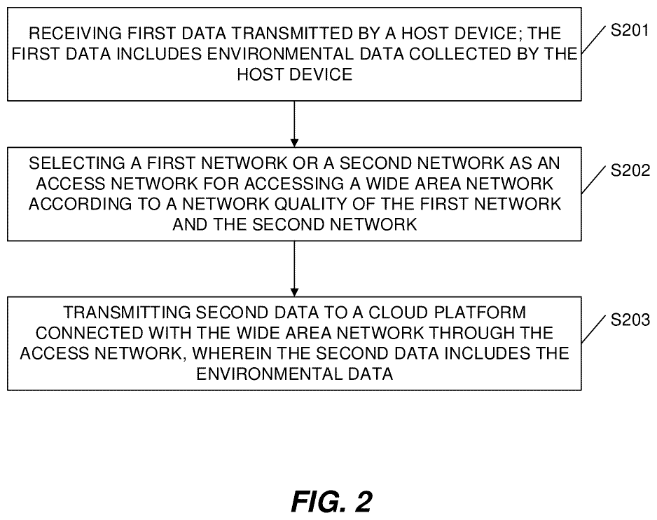

Referring to FIG. 2, it shows a flowchart illustrating a data transmission method according to some embodiments of the present disclosure. The method is executable by a relay device in an intelligent collecting system. The intelligent collecting system includes a host device and the relay device independently deployed within a short range. The relay device includes a first network module and a second network module, the first network module is configured to access a first network, and the second network module is configured to access a second network. The method may include the following operations.

At S201, first data transmitted by the host device is received, the first data including environmental data collected by the host device.

At S202, the first network or the second network is selected as an access network for accessing a wide area network according to a network quality of at least one of the first network and the second network.

At S203, second data is transmitted to a cloud platform connected with the wide area network through the access network, the second data including the environmental data.

In the embodiments of the present disclosure, a distance between the host device and the relay device is less than a preset distance threshold value, for example, less than 100 meters so that the reliability and stability of data transmission between the host device and the relay device may be ensured. At least two network modules are provided in the relay device to access different types of networks. When the environmental data collected by the host device is forwarded to the cloud platform, an appropriate access network is selected for transmission according to the network quality of different networks so that the reliability and stability of data transmission between the relay device and the cloud platform may be ensured.

The embodiments of the present disclosure propose a data transmission method, which may be applied to the intelligent collecting system. The intelligent collecting system includes a host device and a relay device. The host device may be configured to collect environmental data and transmit the collected environmental data to the cloud platform through the relay device. The relay device is configured to forward the environmental data collected by the host device to the cloud platform to improve the data transmission capability of the host device.

Embodiments of the present disclosure do not limit the type of the intelligent collecting system. In some embodiments, the intelligent collecting system may be an intelligent doorbell system, and the intelligent doorbell system includes a host device and a relay device. The host device of the intelligent doorbell system may be deployed outdoors to collect environmental data outdoors, and the relay device of the intelligent doorbell system may be deployed indoors to realize a data forwarding function.

In another example, the intelligent collecting system may be a surveillance system, the host device may be a network camera configured to collect environmental data in real-time in the surveillance system, and the relay device is configured to forward the environmental data collected by the network camera.

The host device and the relay device are two independent devices that may be deployed separately. For example, the host device of the intelligent collecting system may be deployed outdoors to collect environmental data outdoors, and the relay device of the intelligent collecting system may be deployed indoors to realize the data forwarding function.

It will be appreciated that embodiments of the present disclosure do not limit the type of the environmental data collected by the host device. For example, the environmental data may include, but is not limited to, any one or more of the following: image data, video data, and voice data.

Further, the quantity of the host device may be greater than or equal to 1.

It should be noted that in the embodiments of the present disclosure, the description is mainly made with the intelligent collecting system being an intelligent doorbell system as an example, and the processes in other application scenes are similar, and reference may be made to each other.

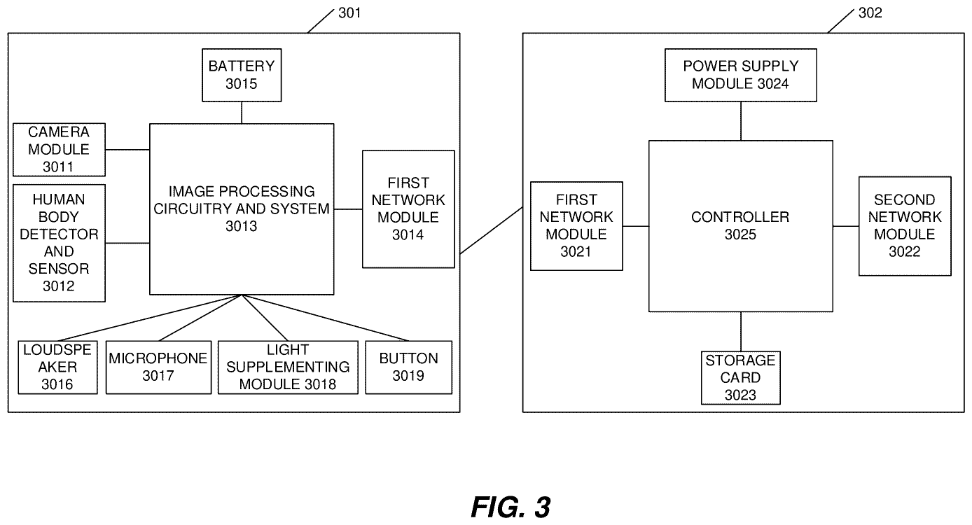

Referring to FIG. 3, it shows a schematic structural diagram of an intelligent doorbell system according to embodiments of the present disclosure. As shown in FIG. 3, the intelligent doorbell system includes a host device 301 and a relay device 302.

It should be noted that the embodiments of the present disclosure do not limit modules included in the host device 301 and modules included in the relay device 302.

Illustratively, the host device 301 includes the following modules: a camera module 3011, a human body detector and sensor 3012, an image processing circuitry and system 3013, a first network module 3014, a battery 3015, a loudspeaker 3016, a microphone 3017, a light supplementing module 3018, and a button 3019.

The camera module 3011 may include a lens and a sensor and is configured to collect images. The human body detector and sensor 3012 may be a passive infrared (PIR) sensor and is configured to detect the presence and movement of a human body. The image processing circuitry and system 3013 is a main processor of the host device 301 and is configured to perform image processing on the collected images and execute the corresponding service logic. The first network module 3014 is a wireless module configured to perform data transmission. For example, the first network module 3014 may be a WiFi network module. The battery 3015 is configured to provide power for the host device 301. The loudspeaker 3016 is configured to output audio. The microphone 3017 is configured to receive audio. The light supplementing module 3018 is configured to supplement illumination. The button 3019 is configured to receive user input.

Illustratively, the relay device 302 includes the following modules: a first network module 3021, a second network module 3022, a memory card 3023, a power supply module 3024, and a controller 3025.

The first network module 3021 is a wireless module configured to perform data transmission. For example, the first network module 3021 may be a WiFi network module. The first network module 3021 may be configured to communicate with the host device 301. In addition, the first network module 3021 may also serve as a pathway to communicate with the cloud platform. The second network module 3022 is a wireless module configured to perform data transmission. For example, the second network module 3022 may be a 4G network module or a 5G network module, etc., and may serve as another pathway to communicate with the cloud platform. The memory card 3023 is configured to store data. For example, the memory card 3023 may be a TransFLash (TF) card. The power supply module 3024, such as an ACDC module, is a power supply module that converts 220V voltage into 5V and is configured to power the relay device 302. The controller 3025 may include a microcontroller unit (MCU) and a system on chip (SOC) and is configured to perform service logic control.

Further, the operation of selecting the first network or the second network as the access network for accessing the wide area network according to the network quality of at least one of the first network and the second network in S202 may be performed by the controller 3025 of the relay device 302.

In the embodiments of the present disclosure, a relay device is added for the host device of the intelligent doorbell to constitute the intelligent doorbell system as shown in FIG. 3. It should be noted that the embodiments of the present disclosure do not limit the communication modes between the host device and the relay device. Illustratively, both the host device and the relay device are provided with the first network module configured to access the first network. The host device may communicate with the relay device through the first network. The host device and the relay device may be deployed separately. For example, the host device of the intelligent doorbell system may be deployed outdoors, and the relay device of the intelligent doorbell system may be deployed indoors. Since the host device is usually fixedly installed somewhere outdoors and the host device may be powered by a battery for ease of installation, it is desirable to reduce the power consumption of the host device to extend the standby time of the host device. Thus, the first network may be a network with low power consumption, such as a WiFi network.

Further, the second network module is also provided in the relay device and is configured to access the second network. The relay device may process the environmental data collected by the host device (also referred to as first data) and forward the processed data (also referred to as second data) to the cloud platform. In the embodiments of the present disclosure, the relay device may transmit second data to the cloud platform through the first network, or the relay device may transmit the second data to the cloud platform through the second network. Specifically, the relay device may select a more suitable access network according to the network quality of the first network and the second network and transmit the second data through the access network.

In the data transmission method provided by the embodiments of the present disclosure, at least two network modules are provided in the relay device, and the coexistence of multiple communication modes may be realized. When the relay device forwards the environmental data collected by the host device to the cloud platform, a more suitable access network may be dynamically selected according to the network quality. When the relay device receives the environmental data transmitted by the host device, the network with low power consumption may be adopted. Thus, in the embodiments of the present disclosure, the stability and reliability for transmitting data to the cloud platform by the host device may be improved through the relay device without increasing the power consumption of the host device and with extended the standby time of the host device as much as possible, so that the overall stability and reliability of the intelligent collecting system (such as the intelligent doorbell system) may be ensured. In addition, at least two network modules are provided in the relay device and may be configured to access different types of networks. Therefore, in the process of forwarding the environmental data collected by the host device, the relay device may dynamically select a network with a better signal quality. When the environmental data contains images or videos, the quality of the images or videos need not to be decreased, and the quality of data transmission may be ensured.

In some embodiments, when determining the access network, in addition to considering the network quality of the first network and the network quality of the second network, the relay device may further consider the data amount of the second data to be transmitted and an available bandwidth of the first network and the second network, so that an access network suitable for the current transmission may be more accurately selected.

It should be noted that the embodiments of the present disclosure do not limit the types of the first network and the second network. For example, the first network may be a network with low power consumption to reduce the power consumption of the host device. The second network may be, compared to the first network, a network with higher power consumption but higher communication capability to improve the data transmission capability of the intelligent collecting system.

In some embodiments of the present disclosure, the first network may include a WiFi network, and the second network may include a mobile data network or a satellite communication network. The mobile data network may include a 4G network or a 5G network. It will be appreciated that the mobile data network is not limited to the 4G network and the 5G network listed above, but may also include mobile data networks that may be used in the future, such as a 6G network.

In the embodiments of the present disclosure, a WiFi network module and a mobile data network module may be provided in the relay device. The mobile data network module may include a 4G network module or a 5G network module. The WiFi network module may be configured to access the WiFi network, the 4G network module may be configured to access the 4G network, and the 5G network module may be configured to access the 5G network.

In order to further improve the stability and reliability of the data transmission of the intelligent collecting system, in the embodiments of the present disclosure, a power amplifier (PA) and a low noise amplifier (LNA) may also be added to the relay device to increase the emission power and sensitivity of the WiFi module, thereby improving the stability and reliability of the data transmission of the intelligent collecting system and increasing a transmission distance.

In some embodiments, the first network module may be a WiFi network module, and the WiFi network module may use an existing or future available WiFi protocol. Illustratively, the WiFi network module may use a WiFi5 protocol, a WiFi6 protocol, or the like.

In some embodiments, the second network module may be a satellite communication module. Satellite communications are communications between radio communication stations on Earth (including on the ground and in the lower atmosphere) using satellites as relays. The satellite communication has a feature of a large communication range. Communication is possible and reliable from any two points as long as they are within the range covered by electric waves emitted by the satellite.

In some embodiments of the present disclosure, the first data may be of a private protocol format agreed between the relay device and the host device.

In the embodiments of the present disclosure, data may be transmitted between the host device and the relay device based on the private protocol format. The private protocol format may be a customized data packet format, which is not limited by the embodiments of the present disclosure. Illustratively, the private protocol format may be a binary format to save the bandwidth required for data transmission, thereby reducing power consumption and delay of data transmission between the host device and the relay device.

Before the relay device transmits the second data to the cloud platform, the method may further include: the controller in the relay device converting the format of the first data from the private protocol format to a protocol format of the access network to obtain the second data.

Specifically, the relay device may receive the first data transmitted by the host device, and the format of the first data is the private protocol format. Before the relay device forwards the first data to the cloud platform, the controller in the relay device converts the format of the first data from the private protocol format to the protocol format of the access network to obtain the second data and transmits the second data to the cloud platform.

In some embodiments of the present disclosure, the network quality may include a signal strength. The selecting the first network or the second network as an access network for accessing a wide area network according to network quality of at least one of the first network and the second network may include the following operations.

The first network is selected as the access network in response to a signal strength of the first network satisfying a first condition.

The second network is selected as the access network in response to the signal strength of the first network not satisfying the first condition and a signal strength of the second network satisfying a second condition.

The signal strength may be received signal strength indication (RSSI).

Embodiments of the present disclosure do not limit the first condition. The first condition is used for indicating that the signal strength of the first network can satisfy a transmission requirement of the second data. Illustratively, the first condition may include: the signal strength of the first network being greater than or equal to a preset value. The preset value may be set according to an actual application scenario. For example, the preset value should satisfy a signal strength value required for stably transmitting the second data by the relay device to the cloud platform. For another example, the preset value may be a minimum signal strength value required for establishing a network connection between the relay device and the cloud platform, etc. Illustratively, the preset value may be set to a RSSI value of −70 dBm.

Embodiments of the present disclosure do not limit the second condition. The second condition is used for indicating that the signal strength of the second network can satisfy a transmission requirement of the second data. Illustratively, the second condition may include: the signal strength of the second network being greater than or equal to a preset value. It should be noted that the preset value in the second condition and the preset value in the first condition may be the same or different.

In some examples, it is assumed that the first condition includes: the signal strength of the first network being greater than or equal to −70 dBm; the second condition includes: the signal strength of the second network being greater than or equal to −60 dBm. The second network may be selected as the access network when the relay device detects that the signal strength of the first network is less than −70 dBm and the signal strength of the second network is greater than −60 dBm.

It should be noted that the embodiments of the present disclosure do not limit the type of the network quality. The network quality may include the signal strength. Further, the network quality may include at least one of: a network connection speed, a packet loss rate, or a network delay, to comprehensively evaluate the network quality of the first network and the second network in various aspects.

In some embodiments of the present disclosure, the method may further include: detecting the network quality of the first network and the network quality of the second network periodically at a preset frequency, and switching from one of the first network and the second network which is currently selected to the other when the network quality of at least one of the first network and the second network satisfy a switching condition.

The relay device measures the network quality of the first network and the network quality of the second network periodically at the preset frequency in the process of selecting the access network and transmitting the second data to the cloud platform through the access network. Embodiments of the present disclosure do not limit a value of the preset frequency. For example, if the preset frequency is one second, the relay device performs one operation of measuring the network quality of the first network and the network quality of the second network every one second. In another example, if the preset frequency is three seconds, the relay device performs one operation of detecting the network quality of the first network and the network quality of the second network every three seconds.

During the process of the relay device transmitting the second data to the cloud platform, the network condition of the first network and/or the second network may change. Therefore, in the embodiments of the present disclosure, the network quality of the first network and the network quality of the second network are measured periodically at the preset frequency, and it is switched from one of the first network and the second network currently selected to the other when the network quality of at least one of the first network and the second network satisfies the switching condition. Thus, in the embodiments of the present disclosure, it is able to automatically switch to a network with a better signal quality according to a real-time network condition to reduce network access delay so that the intelligent collecting system may maintain an optimal data transmission quality.

In some embodiments of the present disclosure, the switching from one of the first network and the second network currently selected to the other when the network quality of at least one of the first network and the second network satisfy the switching condition may include the following operations:
when the first network is currently selected as the access network, switching from the first network to the second network in response to detecting that the signal strength of the first network does not satisfy the first condition and the signal strength of the second network satisfies the second condition; or
when the second network is currently selected as the access network, switching from the second network to the first network in response to detecting that the signal strength of the first network satisfies the first condition.

In the embodiment of the present disclosure, a default network may be set, e.g., the default network may be the first network. When the network quality of the first network and the network quality of the second network both satisfy the transmission requirement of the second data, and the signal strengths of them are equal, the default network may be selected as the access network, such as determining that the first network is the access network. During the transmission of the second data, if it is detected that the network quality of the first network decreases and the switching condition is satisfied, it is possible to switch from the first network to the second network. If it is detected that the network quality of the first network restores to satisfy the first condition, it is possible to switch back to the first network from the second network. That is, the second data is transmitted preferably using the default network.

In some embodiments, the default network may also be the second network. The default network may be determined based on network conditions of the first network and the second network, or may be determined based on a user configuration.

In some examples, it is assumed that the first network is a WiFi network, and the second network is a 5G network. If the relay device selects the WiFi network as the access network according to the network quality of the current WiFi network and the network quality of the 5G network, the relay device forwards the environmental data (also referred to as the second data) collected by the host device in real-time to the cloud platform through the WiFi network. In the process of transmitting the second data to the cloud platform, the relay device monitors the network quality of the first network and the network quality of the second network periodically at the preset frequency. When it is detected that the signal strength of the WiFi network is lower than −70 dBm, it is switched from the WiFi network to the 5G network, and the remaining second data is transmitted to the cloud platform through the 5G network. The relay device monitors the network quality of the first network and the second network based on the preset frequency. When it is detected that the signal strength of the WiFi network restores to above −70 dBm, it is switched back to the WiFi network from the 5G network, and the second data is continued to be transmitted to the cloud platform through the WiFi network.

Further, if it is detected that the signal strength of the first network does not satisfy the first condition, and the signal strength of the second network does not satisfy the second condition, it indicates that neither network can satisfy the current transmission requirement. At this time, error information may be transmitted to a user end to prompt network abnormality. Then, proceed to detect the network quality of the first network and the network quality of the second network periodically at the preset frequency and switch from one of the first network and the second network currently selected to the other when the network quality of at least one of the first network and the second network satisfies the switching condition.

In some embodiments of the present disclosure, the method may further include the following operations:
receiving reporting information transmitted by the host device through the first network, and the transmitting the reporting information to the cloud platform through the access network; and
receiving control information through the access network, and transmitting the control information to the host device through the first network.

In some embodiments, the host device and the relay device may also interact with network transmission relevant information. For example, the host device may transmit the reporting information to the relay device, and the relay device forwards the reporting information to the cloud platform. The reporting information includes, but is not limited to, state information of the host device, such as a battery level, a signal strength, and a heartbeat packet of the host device. The relay device may forward control information from the cloud platform or the user end to the host device. The control information may be used for configuring a collecting parameter of the host device, such as configuring the quality of images collected by the host device. Further, the control information may also be used for querying the state information of the host device, etc.

In some embodiments, the reporting information and the control information transmitted between the host device and the relay device may be based on the private protocol format. Further, the host device and the relay device may transmit the reporting information and the control information through the first network. When the relay device forwards the reporting information of the host device to the cloud platform, the reporting information needs to be converted into the protocol format of the access network and then be transmitted. When the relay device forwards the control information to the host device, the control information needs to be converted into the private protocol format and then be transmitted.

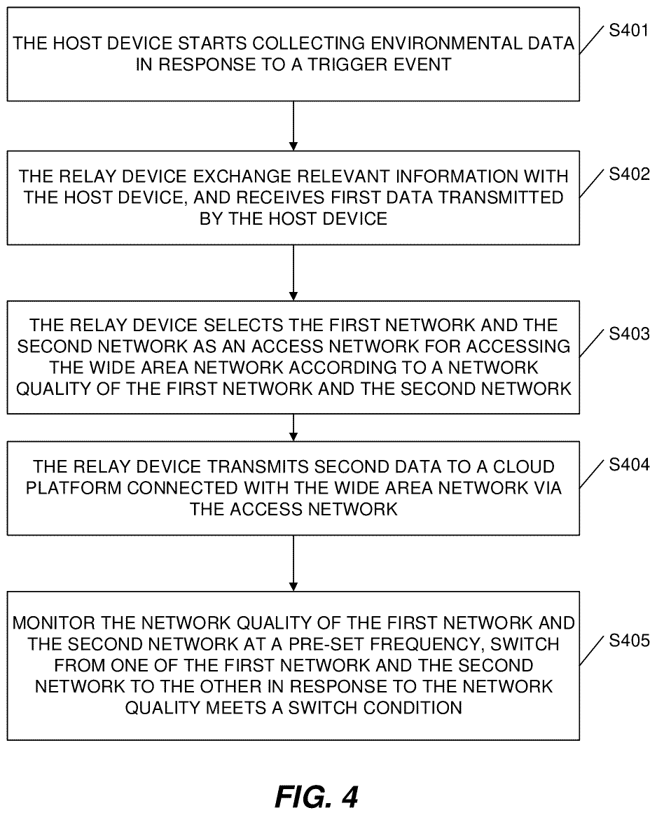

Referring to FIG. 4, it shows a flowchart of another data transmission method according to embodiments of the present disclosure. The method is applied to an intelligent collecting system, and the intelligent collecting system may be an intelligent doorbell system. The intelligent doorbell system includes a host device and a relay device independently deployed within short range. The relay device includes a first network module and a second network module, the first network module is configured to access a first network, and the second network module is configured to access a second network. The method may include the following operations.

At S401, the host device starts to collect environmental data in response to a triggering event.

In some embodiments, in order to reduce the power consumption of the host device, the host device is always in a standby state. When a trigger event is detected, the host device enters a working state to start collecting the environmental data.

The triggering event includes, but is not limited to, an event where the PIR of the host device senses the presence of a human body or an event where a person triggers a button on the host device.

At S402, the relay device interacts relevant information with the host device and receives first data transmitted by the host device.

The relevant information includes: reporting information transmitted by the host device and control information forwarded by the relay device.

Further, the relay device and the host device may interact with relevant information through the first network. The first network may be a WiFi network.

Further, the relevant information may be transmitted based on the private protocol format.

The host device performs configuration according to the received control information, collects environmental data, and transmits the environmental data to the relay device.

At S403, the relay device selects the first network or the second network as an access network for accessing a wide area network according to a network quality of at least one of the first network and the second network.

Further, the relay device may select the first network or the second network as the access network for accessing the wide area network by comprehensively considering the network quality of the first network and the network quality of the second network, data amount of the second data to be transmitted, and an available bandwidth of the first network and the second network.

In some embodiments, when selecting the access network, with regard to the above-mentioned multiple factors, corresponding priorities may be set, and the factor with the highest priority is preferably considered. Illustratively, the signal strength is set with the highest priority. It is assumed that the current available bandwidth of the first network and the available bandwidth of the second network both satisfy the data amount of the second data to be transmitted, the signal strength of the first network satisfies a first condition, and the signal strength of the second network satisfies a second condition, i.e., various factors of the first network and the second network satisfy the current transmission requirement. At this time, the network with a higher signal strength may be selected as the access network. For example, when the signal strength of the first network is higher than the signal strength of the second network, the first network may be selected as the access network. It will be appreciated that embodiments of the present disclosure do not limit the specific manner for selecting the access network.

At S404, the relay device transmits second data to a cloud platform connected with the wide area network through the access network.

The relay device sets a communication interface according to the access network selected in S403. For example, if the selected access network is the first network, the first network module is configured as the communication interface. If the selected access network is the second network, the communication interface is set to be the second network module. The relay device sets a bandwidth requirement for the second data according to the data amount of the second data to be transmitted.

The relay device establishes a transmission channel corresponding to the access network with the cloud platform through the set communication interface and transmits the second data through the transmission channel.

At S405, the network quality of the first network and the network quality of the second network are monitored periodically at a preset frequency, and it is switched from one of the first network and the second network which is currently selected to the other when the network quality of at least one of the first network and the second network satisfies a switching condition.

In the process of transmitting the second data to the cloud platform, the relay device measures the network quality of the access network periodically at a certain frequency, and when the network quality of the access network satisfies the switching condition, it is switched from one of the first network and the second network which is currently selected to the other in time to dynamically select a network with a better signal.

In summary, the embodiments of the present disclosure provides a data transmission method, where a corresponding relay device is added for the host device of the intelligent doorbell, and the relay device may forward the environmental data collected by the host device to the cloud platform. At least two network modules are provided in the relay device, and the coexistence of multiple communication modes may be realized. When the relay device forwards the environmental data collected by the host device to the cloud platform, a more suitable access network may be dynamically selected according to the network quality. Due to a close distance between the relay device and the host device, the relay device may adopt a network with low power consumption to reduce the power consumption of the host device when receiving the environmental data transmitted by the host device. Thus, in the embodiments of the present disclosure, the stability and reliability of the host device for transmitting data to the cloud platform may be improved through the relay device with reduced the power consumption of the host device and extended standby time of the host device as much as possible, so that the overall stability and reliability of the intelligent collecting system may be ensured and the normal playing function of the user terminal may be ensured. In addition, at least two network modules are provided in the relay device and may be configured to access different types of networks. Therefore, in the process of forwarding the environmental data collected by the host device, the relay device may dynamically select a network with a better signal for transmission. When the environmental data contains images or videos, the quality of the images or videos need not be decreased, and the quality of data transmission may be ensured. Further, in the embodiments of the present disclosure, the relay device is added for the host device of the intelligent doorbell to constitute the intelligent collecting system. The intelligent collecting system has multiple communication modes and may satisfy a higher data transmission requirement. The host device and the relay device may be deployed independently so that the intelligent collecting system may be fit for more application scenarios to satisfy more different user requirements.

It should be noted that for simplicity of explanation, method embodiments are expressed as a series of action combinations. However, a person skilled in the art will recognize that the embodiments of the present disclosure are not limited by an order of actions described, as certain steps may be performed in other orders or simultaneously according to the embodiments of the present disclosure. Secondly, a person skilled in the art will also recognize that the embodiments described in the description are all preferred embodiments, and the actions involved are not necessarily required by the embodiments of the present disclosure.

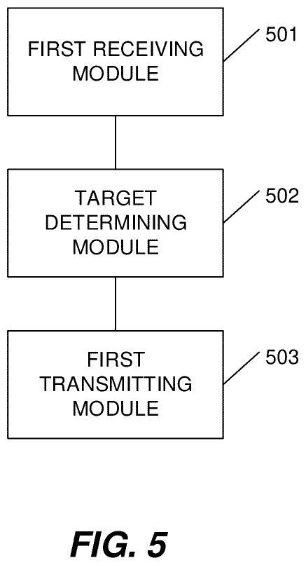

Referring to FIG. 5, it shows a block diagram of a data transmission apparatus according to embodiments the present disclosure. The apparatus is applied to a relay device in an intelligent collecting system. The intelligent collecting system includes a host device and the relay device independently deployed within short range. The relay device includes a first network module and a second network module, the first network module is configured to access a first network, and the second network module is configured to access a second network. The apparatus includes:
a first receiving module 501, configured to receive first data transmitted by the host device, the first data including environmental data collected by the host device;
a target determination module 502, configured to select the first network or the second network as an access network for accessing a wide area network according to network quality of at least one of the first network and the second network; and
a first transmitting module 503, configured to transmit second data to a cloud platform connected with the wide area network through the access network, the second data including the environmental data.

Referring to FIG. 3, it shows a schematic structural diagram of an intelligent collecting system according to embodiments the present disclosure. The intelligent collecting system includes a host device 301 and a relay device 302. The relay device includes a first network module and a second network module, the first network module is configured to access a first network, and the second network module is configured to access a second network.

The host device 301 is configured to collect environmental data and transmit first data to the relay device, the first data including the environmental data collected by the host device.

The relay device 302 is configured to receive the first data transmitted by the host device, select the first network or the second network as an access network for accessing a wide area network according to a network quality of the first network and the second network, and transmit second data to a cloud platform connected with the wide area network through the access network, the second data including the received environmental data.

With respect to the apparatus embodiment, which is substantially similar to the method embodiment, the description is relatively simple with reference to the partial description of the method embodiment.

The embodiments in this specification are described in an incremental manner, with each embodiment focusing on differences from the other embodiments, with like parts referring to each other.

With respect to the apparatus in the above-described embodiment, the specific manner in which the various modules perform operations has been described in detail in connection with the embodiments of the method and will not be described in detail herein.

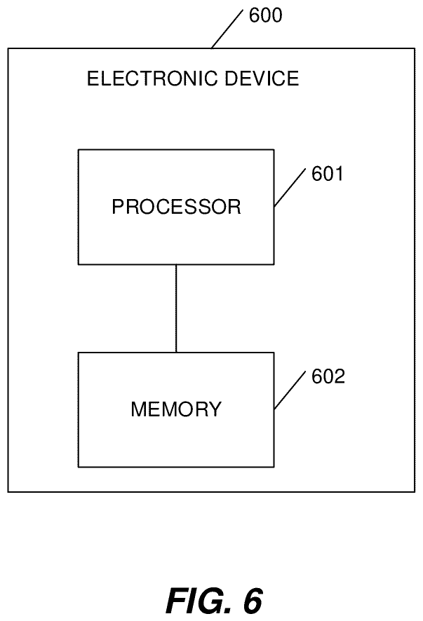

FIG. 6 is a schematic structural diagram of an electronic device 600 according to embodiments of the present disclosure. The electronic device 600 may vary widely in configuration or performance and may include one or more central processing units (CPUs) 601 and one or more memories 602 having at least one program code stored therein. The at least one program code is loaded and executed by the processor 601 to implement the data transmission method as described in FIG. 2. In some embodiments, the electronic device 600 may have a wired or wireless network interface, a keyboard, an input/output interface, and other components for inputting/outputting. The electronic device 600 may also include other components for implementing device functions, which will not be described in detail herein.

The embodiments of the present disclosure also provides a non-transitory computer-readable storage medium storing instructions which, when executed by a processor of an apparatus (a server or a terminal), enable the apparatus to perform the data transmission method in the embodiments corresponding to FIG. 2. For technical details of the computer program product or computer program embodiments not disclosed in the present disclosure, reference is made to the description of method embodiments of the present disclosure.

Other embodiments of the present disclosure will be apparent to a person skilled in the art from consideration of the specification and practice of the invention disclosed herein. The present disclosure is intended to cover any variations, uses, or adaptations of the present disclosure that follow the general principles of the present disclosure and include common knowledge or customary technical means in the art not disclosed herein. The specification and embodiments are to be regarded as exemplary only, and the true scope and spirit of the present disclosure is indicated by the following claims.

It should be understood that the present disclosure is not limited to the precise structures described above and shown in the accompanying drawings, and that various modifications and changes may be made without departing from the scope thereof. The scope of the present disclosure is limited only by the accompanying claims.

The above mentioned are only preferred embodiments of the present disclosure and are not intended to limit the present disclosure, and any modifications, equivalent substitutions, improvements, etc. made within the spirit and principles of the present disclosure shall be included in the scope of the present disclosure.

The data transmission method, data transmission apparatus, intelligent collecting system, and machine-readable storage medium provided by the present disclosure are described in detail above, and the principles and embodiments of the present disclosure are described herein using specific examples. The above description of the embodiments is only for helping to understand the method and the core idea of the present disclosure. Meanwhile, for a person skilled in the art, according to the idea of the present disclosure, there would be changes in the specific implementations and the application scope. In summary, the contents of the specification should not be construed as limiting the present disclosure.

1. A data transmission method, executed by a relay device in an intelligent collecting system, wherein the intelligent collecting system comprises a host device and the relay device independently deployed within short range; the relay device comprises a first network module and a second network module, the first network module is configured to access a first network, and the second network module is configured to access a second network; and the method comprises:
receiving first data transmitted by the host device, the first data comprising environmental data collected by the host device;
selecting the first network or the second network as an access network for accessing a wide area network according to a network quality of at least one of the first network and the second network; and
transmitting second data to a cloud platform connected with the wide area network through the access network, the second data comprising the environmental data.

2. The method according to claim 1, wherein a distance between the host device and the relay device is less than a preset distance threshold value.

3. The method according to claim 1, wherein host device comprises a third network module which is configured to access the first network, and communication between the host device and the relay device is implemented through the first network.

4. The method according to claim 1, wherein the first network comprises a wireless fidelity (WiFi) network, and the second network comprises a radio data network or a satellite communication network.

5. The method according to claim 1, wherein the first data is in a private protocol format agreed between the relay device and the host device; relay device further comprises a controller; and before transmitting the second data to the cloud platform, the method further comprises:
converting, by the controller, the format of the first data from the private protocol format to a protocol format of the access network to obtain the second data.

6. The method according to claim 1, wherein the network quality comprises a signal strength; and the selecting the first network or the second network as the access network for accessing the wide area network according to network quality of at least one of the first network and the second network comprises:
selecting the first network as the access network in response to the signal strength of the first network satisfying a first condition; or
selecting the second network as the access network in response to the signal strength of the first network not satisfying the first condition and the signal strength of the second network satisfying a second condition.

7. The method according to claim 6, wherein the first condition comprises: the signal strength of the first network being greater than or equal to a first preset value;
the second condition comprises: the signal strength of the second network being greater than or equal to a second preset value.

8. The method according to claim 1, further comprising:
detecting the network quality of the first network and the network quality of the second network periodically at a preset frequency, and switching from one of the first network and the second network which is currently selected to the other when the network quality of at least one of the first network and the second network satisfies a switching condition.

9. The method according to claim 8, wherein the switching from one of the first network and the second network which is currently selected to the other when the network quality of at least one of the first network and the second network satisfies the switching condition comprises:
if the currently selected network is the first network, switching from the first network to the second network in response to detecting that a signal strength of the first network does not satisfy a first condition and a signal strength of the second network satisfies a second condition; or
if the currently selected network is the second network, switching from the second network to the first network in response to detecting that the signal strength of the first network satisfies the first condition.

10. The method according to claim 1, further comprising:
receiving reporting information transmitted by the host device through the first network, and transmitting the reporting information to the cloud platform through the access network; or
receiving control information through the access network, and transmitting the control information to the host device through the first network.

11. The method according to claim 10, wherein the reporting information at least comprises state information of the host device; the state information of the host device comprises at least one of a battery level, a signal strength, or a heartbeat packet of the host device;
the control information is used for configuring a collecting parameter of the host device and/or for querying the state information of the host device.

12. The method according to claim 1, wherein a quantity of the host device is greater than or equal to 1.

13. The method according to claim 1, wherein the relay device further comprises at least one of a power amplifier (PA) or a low noise amplifier (LNA).

14. A data transmission apparatus, applied to a relay device in an intelligent collecting system, wherein the intelligent collecting system comprises a host device and the relay device independently deployed within short range; the relay device comprises a first network module and a second network module, the first network module is configured to access a first network, and the second network module is configured to access a second network; and the apparatus comprises a memory for storing instructions and a processor for executing the instructions to cause the data transmission apparatus to:
receive first data transmitted by the host device, the first data comprising environmental data collected by the host device;
select the first network or the second network as an access network for accessing a wide area network according to network quality of at least one of the first network and the second network; and
transmit second data to a cloud platform connected with the wide area network through the access network, the second data comprising the environmental data.

15. (canceled)

16. (canceled)

17. A non-transitory computer-readable storage medium having instructions stored therein, which when executed by one or more processors of an apparatus, cause the apparatus to execute a method comprising:
receiving first data transmitted by a host device, the first data comprising environmental data collected by the host device; wherein the host device is deployed in an intelligent collecting system, the intelligent collecting system comprises the host device and a relay device independently deployed within short range; the relay device comprises a first network module and a second network module, the first network module is configured to access a first network, and the second network module is configured to access a second network;
selecting the first network or the second network as an access network for accessing a wide area network according to a network quality of at least one of the first network and the second network; and
transmitting second data to a cloud platform connected with the wide area network through the access network, the second data comprising the environmental data.

18. (canceled)

19. The data transmission apparatus according to claim 14, wherein a distance between the host device and the relay device is less than a preset distance threshold value.

20. The data transmission apparatus according to claim 14, wherein host device comprises a third network module which is configured to access the first network, and communication between the host device and the relay device is implemented through the first network.

21. The non-transitory computer-readable storage medium according to claim 17, wherein a distance between the host device and the relay device is less than a preset distance threshold value.

22. The non-transitory computer-readable storage medium according to claim 17, wherein host device comprises a third network module which is configured to access the first network, and communication between the host device and the relay device is implemented through the first network.

23. The non-transitory computer-readable storage medium according to claim 17, wherein the first network comprises a wireless fidelity (WiFi) network, and the second network comprises a radio data network or a satellite communication network.
